(19) United States
(12) Patent Application Publication
(10) Pub. No.: US 2010/0111221 A1
(43) Pub. Date: May 6, 2010

(54) OPTIMIZED DIGITAL CORRECTION FOR POWER AMPLIFIER DISTORTION AND QUADRATURE ERROR

(75) Inventors: Gregory T. Nash, Arlingotn Heights, IL (US); Michael S. Gleason, McHenry, IL (US); Thomas J. Kundmann, Cary, IL (US)

Correspondence Address: MOTOROLA, INC, 1303 EAST ALGONQUIN ROAD, IL01/3RD, SCHAUMBURG, IL, 60196, US

(73) Assignee: Motorola, Inc., Schaumburg, IL (US)

(21) Appl. No.: 12/261,534

(22) Filed: Oct. 30, 2008

(51) Int. Cl. H04L 25/03

(52) U.S. Cl. 375/296

(57) ABSTRACT

A method, wireless device, and wireless communication system manage quadrature and non-linear distortions in a transmitter system (100). A transmit data signal (235) is generated from a baseband data signal (202). The transmit data signal (235) can include one or more non-linear and/or quadrature distortions. An RF receiver circuit (238) receives the transmit data signal (235). A received signal, from the RF receiver circuit (238), includes a digital representation of the received transmit data signal (235). The received signal is statistically analyzed (404). A representation of each distortion of the one or more distortions is identified in the transmit data signal (235). At least one information signal (268) including an information set of distortion adjustments is generated. Distortion of the transmit data signal (235) is adjusted (410) based on the information set to reduce the one or more distortions in the transmit data signal (235).

### FIELD OF THE INVENTION

The present invention generally relates to the field of wireless communications, and more particularly relates to managing signal distortion and errors in complex transmitter systems.

### BACKGROUND OF THE INVENTION

Wireless devices include one or more transmitters for transmitting data signals. One type of transmitter is a complex transmitter, which implements a quadrature modulator. These types of transmitters experience various signal distortions from the transmitter components such as power amplifiers and the quadrature modulator. Conventional methods used for correcting these signal distortions generally require factory calibration of the transmitter. However, as the components within the transmitter age or as the environment changes the transmitter usually needs to be recalibrated. This generally requires a technician to come out to the transmitter or for the transmitter to be sent back to the factory. Each of these options is time consuming and can cause the wireless device to experience unnecessary down time.

### SUMMARY OF THE INVENTION

In one embodiment, a new and novel method manages quadrature and non-linear distortions in a transmitter system. The method includes generating a transmit data signal at an output of a transmitter amplifier from a baseband data signal. The transmit data signal can include one or more distortions selected from the set of: Non-linear distortions, Q-offset, I-offset, Quadrature imbalance, and Scaling. A radio frequency (“RF”) receiver circuit receives the transmit data signal generated at the output of the transmitter amplifier. A received signal is generated at an output of the RF receiver circuit that comprises a digital representation of the received transmit data signal. The received signal is statistically analyzed. A representation of each distortion of the one or more distortions is identified in the transmit data signal in response to statistically analyzing the received signal. At least one information signal comprising an information set of distortion adjustments associated with a representation of at least one of the one or more distortions in the transmit data signal is generated in response to the identifying. Distortion of the transmit data signal is adjusted based on the information set of distortion adjustment in the at least one information signal. The adjusting reduces the at least one of the one or more distortions in the transmit data signal.

In another embodiment, a wireless device that manages quadrature and non-linear distortions in a transmitter is disclosed. The wireless device comprises a memory and a processor that is communicatively coupled to the memory. The wireless device also includes at least one transmitter that is communicatively coupled to the memory and the processor. The at least one transmitter comprises a distortion manager and a radio frequency (“RF”) receiver circuit. The at least one transmitter is adapted to generate a transmit data signal at an output of a transmitter amplifier from a baseband data signal. The transmit data signal can include one or more distortions selected from the set of: Non-linear distortions, Q-offset, I-offset, Quadrature imbalance, and Scaling. The RF receiver circuit is adapted to receive the transmit data signal generated at the output of the transmitter amplifier. A received signal is generated at an output of the RF receiver circuit that comprises a digital representation of the received transmit data signal. The distortion manager is adapted to statistically analyze the received signal. The distortion manager identifies a representation of each distortion of the one or more distortions in the transmit data signal in response to statistically analyzing the received signal. The distortion manager, in response to the identifying, generates at least one information signal comprising an information set of distortion adjustments associated with a representation of at least one of the one or more distortions in the transmit data signal. The distortion manager then adjusts distortion of the transmit data signal based on the information set of distortion adjustment in the at least one information signal. The adjusting reduces the at least one of the one or more distortions in the transmit data signal.

In yet another embodiment, a wireless communication system that manages quadrature and non-linear transmit signal distortions is disclosed. The wireless communication system comprises at least one wireless network. At least one wireless device is communicatively coupled to the at least one wireless network. The wireless device comprises a memory and a processor that is communicatively coupled to the memory. The wireless device also includes at least one transmitter that is communicatively coupled to the memory and the processor. The at least one transmitter comprises a distortion manager and a radio frequency (“RF”) receiver circuit. The at least one transmitter is adapted to generate a transmit data signal at an output of a transmitter amplifier from a baseband data signal. The transmit data signal can include one or more distortions selected from the set of: Non-linear distortions, Q-offset, I-offset, Quadrature imbalance, and Scaling. The RF receiver circuit is adapted to receive the transmit data signal generated at the output of the transmitter amplifier. A received signal is generated at an output of the RF receiver circuit that comprises a digital representation of the received transmit data signal. The distortion manager is adapted to statistically analyze the received signal. The distortion manager identifies a representation of each distortion of the one or more distortions in the transmit data signal in response to statistically analyzing the received signal. The distortion manager, in response to the identifying, generates at least one information signal comprising an information set of distortion adjustments associated with a representation of at least one of the one or more distortions in the transmit data signal. The distortion manager then adjusts distortion of the transmit data signal based on the information set of distortion adjustment in the at least one information signal. The adjusting reduces the at least one of the one or more distortions in the transmit data signal.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating an operating environment according to one embodiment of the present invention;

FIG. 2 is a block diagram illustrating a detailed view of a transmitter according to one embodiment of the present invention;

FIGS. 3-4 are operational flow diagrams illustrating one example of continuously and autonomously managing/optimizing non-linear and quadrature distortions in a transmit data signal according to one embodiment of the present invention; and

FIG. 5 is a block diagram illustrating a detailed view of a wireless device according to one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. Additionally, the invention shall have the full scope of the claims and shall not be limited by the embodiments shown below.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. It is further understood that the use of relational terms, if any, such as first, second, top and bottom, front and rear, and the like are used solely for distinguishing one entity or action from another, without necessarily requiring or implying any such actual relationship or order between such entities or actions.

For purposes of this application the term “wireless device” is intended to broadly cover many different types of devices that can wirelessly transmit signals, and optionally can wirelessly received signals, and may also operate in a wireless communication system. For example, and not for any limitation, a wireless device can include (but is not limited to) any one or a combination of the following: a transmitter basestation, a two-way radio, a cellular telephone, a mobile phone, a smartphone, a two-way pager, a wireless messaging device, a laptop/computer, automotive gateway, or a residential gateway.

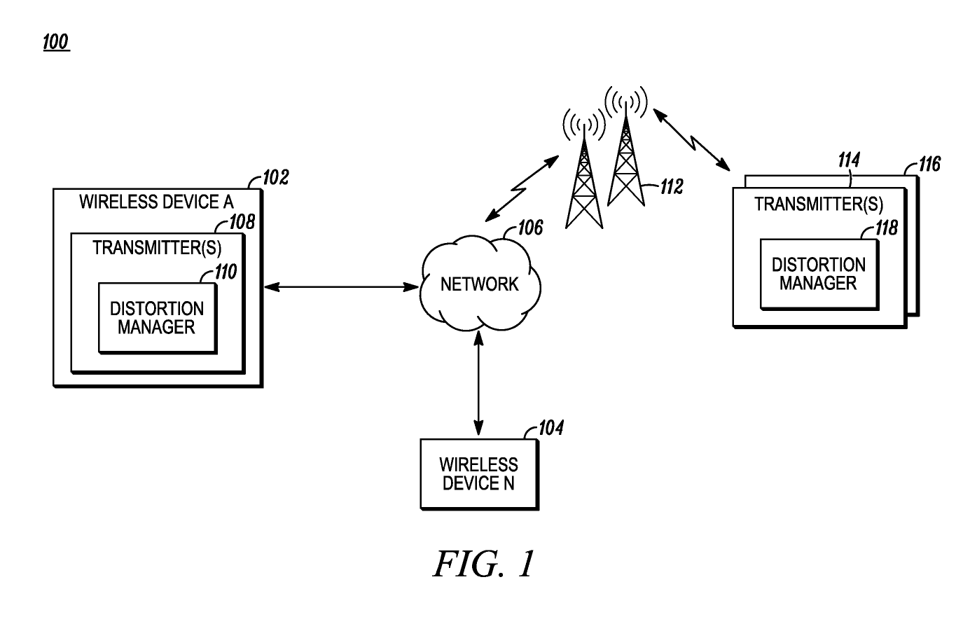

According to one embodiment of the present invention as shown in FIG. 1 one example of a wireless communication system 100 is illustrated. In particular, FIG. 1 shows one or more wireless devices 102, 104 communicatively coupled to one or more wireless communication networks 106. Each wireless device 102, 104 includes one or more transmitters 108. In one embodiment, the transmitters 108 are zero intermediate frequency transmitters. However, the present invention is also applicable to any type of transmitter with a quadrature modulator or any complex intermediate frequency system as well. The transmitter 108 includes a distortion manager 110. The distortion manager 110 automatically and continuously corrects non-linear and quadrature distortions without the need for factory calibrations. The distortion manager 110 is discussed in greater detail below.

It should be noted that although FIG. 1 shows two wireless devices, the wireless communication system 100 supports any number of wireless devices 102, 104, which can be single mode or multi-mode devices. Multi-mode devices are capable of communicating over multiple access networks with varying technologies. For example, a multi-mode wireless device can communicate over various access networks such as GSM, UMTS, CDMA, or WiFi. In addition, multiple communication protocols such as Push-To-Talk (PTT), Push-To-Talk Over Cellular (PoC), voice traffic channel, multimedia messaging, web browsing, Voice over IP (VoIP), and multimedia streaming may be utilized.

The wireless communication network 106 can include one or more networks such as a circuit service network and/or a packet data network. The communication network 106 can either be wired or wireless. The wireless communications standard of the network 106 can comprise Code Division Multiple Access (“CDMA”), Time Division Multiple Access (“TDMA”), Global System for Mobile Communications (“GSM”), General Packet Radio Service (“GPRS”), Frequency Division Multiple Access (“FDMA”), other IEEE 802.16 standards, Orthogonal Frequency Division Multiplexing (“OFDM”), Orthogonal Frequency Division Multiple Access (“OFDMA”), Wireless LAN (“WLAN”), WiMAX, or the like. The wireless communication network 106 is able to include an IP or SIP based connectivity network, which provides data connections at much higher transfer rates then a traditional circuit services network. These networks are able to comprise an Evolution Data Only (“EV-DO”) network, a General Packet Radio Service (“GPRS”) network, a Universal Mobile Telecommunications System (“UMTS”) network, an 802.11 network, an 802.16 (WiMAX) network, Ethernet connectivity, dial-up modem connectivity, or the like. A circuit services network is able to provide, among other things, voice services to the wireless devices 102, 104 communicatively coupled to the network 106. Other applicable communications standards include those used for Public Safety Communication Networks including TErrestrial TRunked rAdio (“TETRA”) and P25 Trunking. It should be noted that these network technologies are only used as an illustrative example and do not limit further embodiments of the present invention.

The wireless communication system 100 also includes one or more base stations 112 communicatively coupled to the wireless communication network(s) 106. Each base station 112 includes one or more transmitters 114, 116. One or more of these transmitters 114, 116 can be similar to the transmitter 108 discussed above. For example, one or more of these transmitters 114, 116 can include a distortion manager 118.

As discussed above, transmitter systems that implement quadrature modulators experience quadrature distortions/errors that limit vector accuracy and spectral performance. Non-linear distortions/errors are also experienced from power amplifiers within the transmitter systems as well. The transmitter system 108 of the various embodiments of the present invention utilizes a distortion manager 110 that continuously monitors a transmit signal for non-linear distortions created by power amplifiers and quadrature distortions created by a quadrature modulator within the transmitter and adjusts the transmit signal until these distortions reach zero. For example, the distortion manager 110 receives a transmit signal and generates a digital representation of the received signal. The distortion manager 110 then statistically analyzes the received signal and identifies a representation of each distortion within the received signal. An information signal including an information set of distortion adjustments associated with the identified distortion representations is then generated by the distortion manager 110. The distortion manger 108 based on the information signal then adjusts the distortions of the transmit signal, thereby reducing at least one distortion in the transmit signal. The process can be continually performed by the distortion manager 110 to effectively reduce the distortions of the transmit signal to zero.

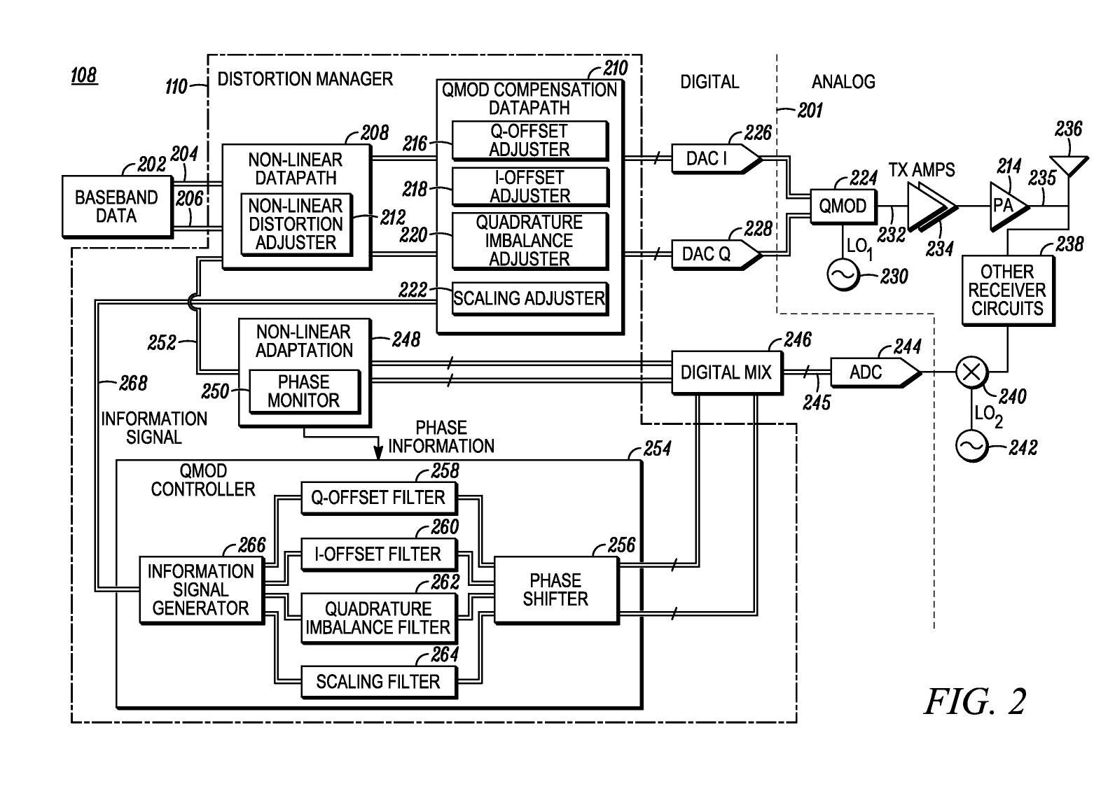

FIG. 2 shows a more detailed view of a transmitter 108 including a distortion manager 110. It should be noted that although the above discussion is with respect to a transmit data signal, the various embodiments are also applicable to a received signal as well as noise and can manage transmit/received signal distortions in a single system. It is assumed that the reader is familiar with wireless transmitters. Therefore, to simplify the present discussion, only the portion(s) of a transmitter that is relevant to the various embodiments of the present invention is discussed in detail. In particular, FIG. 2 shows digital components and analog components of the transmitter 108 separated by the dashed line 201. The distortion manager 110 shown by a dashed-dotted box, in one embodiment, comprises a non-linear pre-distortion engine or non-linear datapath 208, a quadrature modulator pre-distortion or QMod compensation datapath 210, a QMod controller 254, and a non-linear adaptation module 248, all of which are discussed in greater detail below.

FIG. 2 shows baseband data 202 that represents a transmit data signal that is to be transmitted by the transmitter 108. As discussed above, the transmitter 108, in one embodiment, is a complex IF transmitter. Therefore, the transmit data signal 202 comprises an I component 204 and a Q component 206. The transmitter 108 includes a digital pre-distortion module or non-linear datapath 208 and a quadrature modulator pre-distortion or QMod compensation datapath 210. The non-linear datapath 208 is a pre-distortion engine (such as a lookup table, etc.) that includes a non-linear distortion adjuster 212 that adjusts the baseband signal 202 to reduce or eliminate non-linear distortions caused by the power amplifier 214. The QMod compensation datapath 210 includes quadrature distortion adjusters such as a Q-offset adjuster 216, an I-offset adjuster 218, a Quadrature imbalance adjuster 220, and a Scaling adjuster 222 that adjusts the baseband signal 202 to reduce or eliminate quadrature distortions such as Q-offset, I-offset, Quadrature imbalance, and Scaling distortions caused by the quadrature modulator 224. The non-linear datapath 208, QMod compensation datapath 210, and their components are discussed in greater detail below.

The pre-distorted I and Q components of the baseband data signal 202 outputted by the QMod compensation datapath 210 are each received by a respective digital-to-analog converter (“DAC”) 226, 228. The output of each DAC 226, 228 is then combined by the Qmod 224 with a continuous wave signal generated by a local oscillator 230 to generate a modulated radio frequency (“RF”) signal 232. An RF amplifier stage(s) including transmitter amplifiers 234 and a power amplifier 214 increases the power level of the modulated RF signal 232 prior to the modulated RF signal 232 being applied to an antenna(s) 236 to generate a transmit data signal 235. It should be noted that the baseband signal 202, the modulated radio frequency (“RF”) signal 232, and the transmit data signal 235 discussed above are all the same signal but at different stages within the transmitter 108.

Receiver circuit(s) 238 receives the transmit data signal 235. The receiver circuit(s) 238 samples the received transmit data signal 235. The output of the receiver circuit(s) 238 is mixed down to a given frequency via a mixer 240 electrically coupled to another local oscillator 242 and converted to the digital domain by an analog-to-digital converter (“ADC”) 244 to generate a digital representation 245 of the transmit data signal 235. It should be noted that the local oscillator 230 electrically coupled to the QMod 224 and the local oscillator 242 electrically coupled to the mixer 240 can be the same oscillator circuit or two oscillator circuits that are separate from each other.

If the two local oscillators 230, 242 are different from each other then the output of the ADC 244 is received by a digital mixer 246 to bring the frequency of the digital representation signal 245 back to the original frequency of the baseband signal 202. The output of the digital mixer 246 is received by a non-linear adaptation module 248 that comprises a phase monitor 250. The non-linear adaptation module 248 identifies non-linear distortion characteristics or representations within the received digital representation signal 245. The non-linear adaptation module 248, via the phase monitor 250, determines the relative phase between the transmitter and receiver portions of the transmitter 108 in response to receiving the digital representation signal 245. For example, the phase monitor 250 determines the average complex gain between the transmitter and receiver portions of the transmitter 108. The relative phase is determined because an arbitrary phase shift occurs between the transmitter and receiver portions of the transmitter 108, which can cause system instability. For example, given a 180 degree phase shift, the received I and Q signals would have their signs flopped. Therefore, the phase monitor 250 uses the following calculation to perform a phase recovery operation

$$∠ ( max {r}_{xy} ( n ) ) = {\sum }_{i = 0}^{1} x * ( n - i ) y ( n ) for n = [ 0 … N ] .$$

The results of this calculation are then transmitted to the QMod controller 254 to program a phase shifter 256.

The non-linear adaptation module 248, in one embodiment, generates an information signal 252 based on the non-linear distortion characteristics or representations that have been identified. This information signal 252 comprises an information set of non-linear distortion adjustments that are to be applied to the baseband signal 202 for reducing or eliminating the non-linear distortions created by the power amplifier 214. The non-linear adaptation module 248 then transmits this signal 252 to the non-linear datapath 208 discussed above. The non-linear distortion adjuster 212 uses the information set of non-linear distortion adjustments in the information signal 252 to adjust or pre-distort the baseband signal 202 so that non-linear distortions or reduced or are eliminated. For example, the non-linear distortion adjuster 212 of the non-linear datapath 208, in one embodiment, uses the information set of non-linear distortion adjustments to produce a signal y=f(|x|)*x where y and x are complex valued signals and f(|x|) is an inverse function of the power amplifier 214. Typically, this can be implemented as a table of gains, indexed by the magnitude of the input signal 202, multiplied by the input signal 202. Therefore, the non-linear datapath 208 produces an output signal which is a “pre-distorted” version of the input signal 202, thereby reducing or eliminating any non-linear distortions added to the transmit data signal 235 by the power amplifier 214.

The phase information is transmitted by the non-linear adaptation module 248 to a QMod controller 254, which in one embodiment can be implemented in a field programmable array. The QMod controller 254 uses the received phase information to program a phase rotation in a phase shifter 256. The QMod controller 254 also receives the output of the digital mixer 246 at the phase shifter 256. The QMod controller 254 statistically analyzes the digital representation signal 245 received from the digital mixer 246 to identify a representation of one or more of the distortions in the transmit data signal 235 created by the QMod. For example, the QMod 224 can create one or more of the following distortions within the transmit data signal 235: Q-offset, I-offset, Quadrature/Phase imbalance, and Scaling imbalance. Therefore, in one embodiment, the QMod controller 254 statistically analyzes the digital representation signal 245 to identify a representation of one or more of the Q-offset, I-offset, Quadrature/Phase imbalance, and Scaling imbalance distortions.

In one embodiment, the QMod controller 254 performs the statistical analysis using one or more filters 258, 260, 262, 264 that receive an output signal from the phase shifter 256. These filters are a Q-offset filter 258, an I-offset filter 260, a Quadrature imbalance filter 262, and a Scaling imbalance filter 264. Each filter 258, 260, 262, 264 performs one or more operations on the signal received from the phase shifter 256 and passes an output signal to an information signal generator 266.

The information signal generator 266 takes the results of each filter 258, 260, 262, 264 and generates one or more information signals 268 that includes a signal adjustment information set comprising adjustment information corresponding to one or more of the quadrature distortions (Q-offset, I-offset, Quadrature imbalance, and Scaling imbalance) within the transmit data signal 235. The signal adjustment information set within the information signal 268 instructs the QMod compensation datapath and the Q-offset adjuster 216, I-offset adjuster 218, Quadrature imbalance adjuster 220, and/or Scaling adjuster 222 how to adjust or pre-distort the baseband data signal 202 so that the Quadrature distortions within transmit data signal 235 are reduced or eliminated.

For example, the signal adjustment information set within the information signal 268 can include Q-offset adjustment information, I-offset adjustment information, Quadrature imbalance adjustment information, and/or Scaling imbalance adjustment information. The Q-offset adjuster 216 uses the Q-offset adjustment information to adjust the baseband signal 202 so that Q-offset distortions are reduced or eliminated. The I-offset adjuster 218 uses the I-offset adjustment information to adjust the baseband signal 202 so that I-offset distortions are reduced or eliminated. The Quadrature imbalance adjuster 220 uses the Quadrature imbalance adjustment information to adjust the baseband signal 202 so that Quadrature imbalance distortions are reduced or eliminated. The Scaling adjuster 222 uses the Scaling imbalance adjustment information to adjust the baseband signal 202 so that Scaling imbalance distortions are reduced or eliminated.

In particular, the Q and I offset filters 258, 260, which combined create a DC offset filter, perform the following calculation

$$arg {min}_{c} E [ \hat{Y} ]$$

where E is the expected value operator defined by

$$E [ x ] = {\int }_{- ∞}^{∞} {f}_{x} ( x ) x d {x}_{x}$$

is a random process and fₓ(x) is the probability density function. The variable Y is signal at the output of the Qmod, and c is the value that minimizes DC offset so that adjustment information can be sent to the Q and I offset adjusters 216, 218 in the QMod compensation datapath 210 to eliminate/reduce Q and I offset distortions within the transmit data signal 235. Alternatively, the QMod controller 254 can identify the value or argument of B minimizes E[Y]. Letting Ŷ be the corrected sequence and c be the DC correction factor, a control loop performs the above calculation with the following equation E[Ŷ]=E[Y]−c (EQ 1). The control loop, in one embodiment, is a continuous feedback loop from the receiver 238 into the QMod controller 254 and the non-linear adaptation module 248 that continuously provides data associated with a transmit data signal 235 as input into the QMod controller 254 and the non-linear adaptation module 248 and has as an output information signals comprising distortion adjustment data generated by the QMod controller 254 and the non-linear adaptation module 248.

Using E[Y]=0 as the best minimum results in c=E[Y]. For mean ergodic purposes c is:

$$c = {lim}_{n \to ∞} \frac{1}{n} {\sum }_{i = 0}^{n} {Y}_{i} . \qquad ( EQ 2 )$$

For the iterative process of the distortion manager 110 (e.g., the continuous monitoring of signal distortions and adjustment thereof)

$${c}_{n} = \frac{1}{n} {\sum }_{i = 0}^{n} {Y}_{i} . \qquad ( EQ 3 )$$

Substituting n−1 for n results in

$${c}_{n - 1} = \frac{1}{n - 1} {\sum }_{i = 0}^{n - 1} {Y}_{i} \qquad ( EQ 4 )$$

then removing a term from the sum results in

$${c}_{n} = \frac{1}{n} {Y}_{n} + \frac{1}{n} {\sum }_{i = 0}^{n - 1} {Y}_{i} , \qquad ( EQ 5 )$$

and substituting back results in

$${c}_{n} = \frac{1}{n} {Y}_{n} + \frac{n - 1}{n} {c}_{n - 1} . \qquad ( EQ 6 )$$

Now for a large

$$n , \frac{n}{n - 1} = 1 and \frac{1}{n}$$

is approximated as μ, which is a convergence factor. In one embodiment, the convergence factor μ is set at a small number resulting in cₙ=μYₙ+cₙ₋₁ (EQ 7). Updating c results in some power being left in the estimate E[Ŷ]. Therefore, the relative level of the offset power relative to the signal power is

$$\frac{VAR [ Y ]}{VAR [ c - {c}_{n} ]} = \frac{VAR [ Y ]}{VAR [ μ Y ]} = \frac{1}{μ} . \qquad ( EQ 8 )$$

In general terms, the limiting dBc of the DC offset is 1/μ. It should be noted that one advantage of this algorithm is that the remaining DC offset energy is spread by the bandwidth of the transmitted signal. Also, since 1/μ is about 1/n the algorithm is as converged as it will be in 1/μ iterations. Therefore, this achieves perfect convergence as μ→0 and n→∞. As a result of the above process, cₙ=μYₙ+cₙ₋₁ (EQ 7) (which is a combined result of the Q-offset and I-offset filters 258, 260) is used by the information signal generator 266 to generate an information signal 268 comprising DC offset (i.e., Q-offset and I-offset) distortion adjustment information for the Q-offset and I-offset adjusters 216, 218 in the QMod compensation datapath 210.

With respect to Quadrature/Phase imbalance distortions, the Quadrature imbalance filter 262 performs the following calculation

$${argmin}_{α} E [ ( \hat{Y} ) ( \hat{Y} ) ] \qquad ( EQ 9 )$$

where Y is the signal seen at the output of the QMod and R and I are the real and imaginary operators, so that adjustment information can be sent to the Quadrature/Phase imbalance adjuster 220 in the QMod compensation datapath 210 to eliminate/reduce Quadrature/Phase imbalance distortions within the transmit data signal 235. Letting α be the phase correction factor, the estimate of the corrected signal is calculated as follows: Ŷ=Y−j [symbol] (Y)=Yᵢ+j(Y_{q}−αYᵢ) (EQ 10), where Yᵢ= [symbol] (Y) and Y_{q}= [symbol] (Y). Assuming that a minimum of 0 can be obtained for the correlation: E[(Yᵢ)(Y_{q}−αYᵢ)]=0 (EQ 11), E[YᵢY_{q}]−αE[YᵢYᵢ]=0 (EQ 12), and

$$α = \frac{COV [ {Y}_{i} {Y}_{q} ]}{VAR [ {Y}_{i} ]} . \qquad ( EQ 13 )$$

VAR[Yᵢ] is normalized so that VAR[Yᵢ]=1 and a is made a series in an iterative process resulting in

$${α}_{n} = \frac{1}{n} {\sum }_{r = 0}^{n} {Y}_{ir} {Y}_{qr} . \qquad ( EQ 14 )$$

Substituting n−1 for n results in

$${α}_{n - 1} = \frac{1}{n - 1} {\sum }_{r = 0}^{n - 1} {Y}_{ir} {Y}_{qr} . \qquad ( EQ 15 )$$

Removing a term from the sum results in

$${α}_{n} = \frac{1}{n} {Y}_{i n} {Y}_{qn} + \frac{1}{n} {\sum }_{r = 0}^{n - 1} {Y}_{ir} {Y}_{qr} \qquad ( EQ 16 )$$

and substituting back in yields

$${α}_{n} = \frac{1}{n} {Y}_{i n} {Y}_{qn} + \frac{n - 1}{n} {α}_{n - 1} . \qquad ( EQ 17 )$$

Using similar approximations as discussed above,

$$\frac{n}{n - 1} = 1 and \frac{1}{n}$$

as μ results in αₙ=μYᵢₙY_{qn}+αₙ₋₁ (EQ 18). Using similar math and logic as discussed above with respect to the DC offset calculation, the radio of power in the signal to power in the phase imbalance is μ and 1/μ iterations are needed to converge. As a result of the above process, αₙ=μYᵢₙY_{qn}+αₙ₋₁ (EQ 18) is used by the information signal generator 266 to generate an information signal 268 comprising Quadrature/Phase imbalance distortion adjust information for the Quadrature imbalance adjusters 220 in the QMod compensation datapath 210.

With respect to Scaling imbalance distortions, the Scaling filter 264 performs the following calculation

$${argmin}_{β} VAR [ ( \hat{Y} ) ] - VAR [ ( \hat{Y} ) ]$$

so that adjustment information can be sent to the Scaling adjuster 222 in the QMod compensation datapath 210 to eliminate/reduce Scaling imbalance distortions within the transmit data signal 235. R and I are the real and imaginary operators. β is set as the scaling correction coefficient and an estimate of the corrected signal is defined as Ŷ= [symbol] (Y)+jβ [symbol] (Y)=Yᵢ+jY_{q} (EQ 19). Since the minimum should again be 0, 0==E[Yᵢ²]−βE[Y_{q}²] (EQ 20). Solving for β results in

$$β = \frac{E [ {Y}_{i}^{2} ]}{E [ {Y}_{q}^{2} ]} , \qquad ( EQ 21 )$$

### v (EQ 22), and

$$log {β}_{n} = log \frac{1}{n} {\sum }_{r = 0}^{n} {Y}_{ir}^{2} - log \frac{1}{n} {\sum }_{r = 0}^{n} {Y}_{qr}^{2} . \qquad ( EQ 23 )$$

Because the Qmod controller 254 performs an iterative process, the first derivatives are to be equal and the extrema are to fall at the dame locations. In this case, the following substitutions are true and useful. First log x→x is consistent for 0<x<∞. Secondly, log x→|x| for all. In both cases for positive x the first derivative is positive, and for negative x the first derivative is negative. In the second case, both functions have one minimum at x=0. Thus,

$$\begin{matrix}{β}_{n} = \frac{1}{n} {\sum }_{r = 0}^{n} \vert {Y}_{ir} \vert - \frac{1}{n} {\sum }_{r = 0}^{n} \vert {Y}_{qr} \vert \\ and & ( EQ 24 ) \\ {β}_{n} = \frac{1}{n} {\sum }_{r = 0}^{n} ( \vert {Y}_{ir} \vert - \vert {Y}_{qr} \vert ) . & ( EQ 25 )\end{matrix}$$

Substituting n−1 for n results in

$${β}_{n - 1} = \frac{1}{n - 1} {\sum }_{r = 0}^{n - 1} ( \vert {Y}_{ir} \vert - \vert {Y}_{qr} \vert ) . \qquad ( EQ 26 )$$

Removing a term results in

$${β}_{n} = \frac{1}{n} ( \vert {Y}_{i n} \vert - \vert {Y}_{qn} \vert ) + \frac{1}{n} {\sum }_{r = 0}^{n} ( \vert {Y}_{ir} \vert - \vert {Y}_{qr} \vert ) . \qquad ( EQ 27 )$$

Substituting back in yields

$${β}_{n} = \frac{1}{n} ( \vert {Y}_{i n} \vert - \vert {Y}_{qn} \vert ) + \frac{n - 1}{n} {β}_{n - 1} \qquad ( EQ 28 )$$

and βₙ=μ(|Yᵢₙ|−|Y_{qn}|)+βₙ₋₁ (EQ 29). As a result of the above process, EQ 29 is used by the information signal generator 266 to generate an information signal 268 comprising Scaling imbalance distortion adjust information for the Scaling imbalance adjusters 222 in the QMod compensation datapath 210.

Therefore, as a result of the above process performed by the filters 258, 260, 262, 264 the information signal generator 266 receives a DC correction factor c (See EQ 7 above), a Quadrature imbalance correction factor α (See EQ 18 above), and a Scaling imbalance correction coefficient β (See EQ 29 above). The information signal generator 266 generates an information signal 268 that comprises this distortion adjustment information and transmits the information signal 268 to the QMod compensation datapath 210. Each adjuster 216, 218, 220, 222 receives the appropriate adjust information and adjusts the baseband signal 202 such that the corresponding distortions added to the signal 202 by the QMod 224 are removed or reduced. In particular, the QMod compensation datapath 210 produces an output signal y=real(x)+j*(imag(x)*β+α*real(x))+c from the input signal 202, where α and β are real valued numbers, y and x are a complex valued signal, and c is a complex number.

As can be seen from the above discussion, the various embodiments of the present invention advantageously manage non-linear and quadrature distortions in a continuous and autonomous way. For example, the distortion manager 110 continuously receives sampled data from a transmit data signal 235, identifies the distortions within the transmit data signal 235, generates signal adjustment information, and transmits this signal adjustment information to the non-linear and QMod compensation datapath 208, 210 so that signal corrections can be applied prior to the QMod 224 and power amplifier 214 inserting the distortions. Therefore, when the QMod 224 and power amplifier 214 insert their distortions, these distortions are reduced or eliminated.

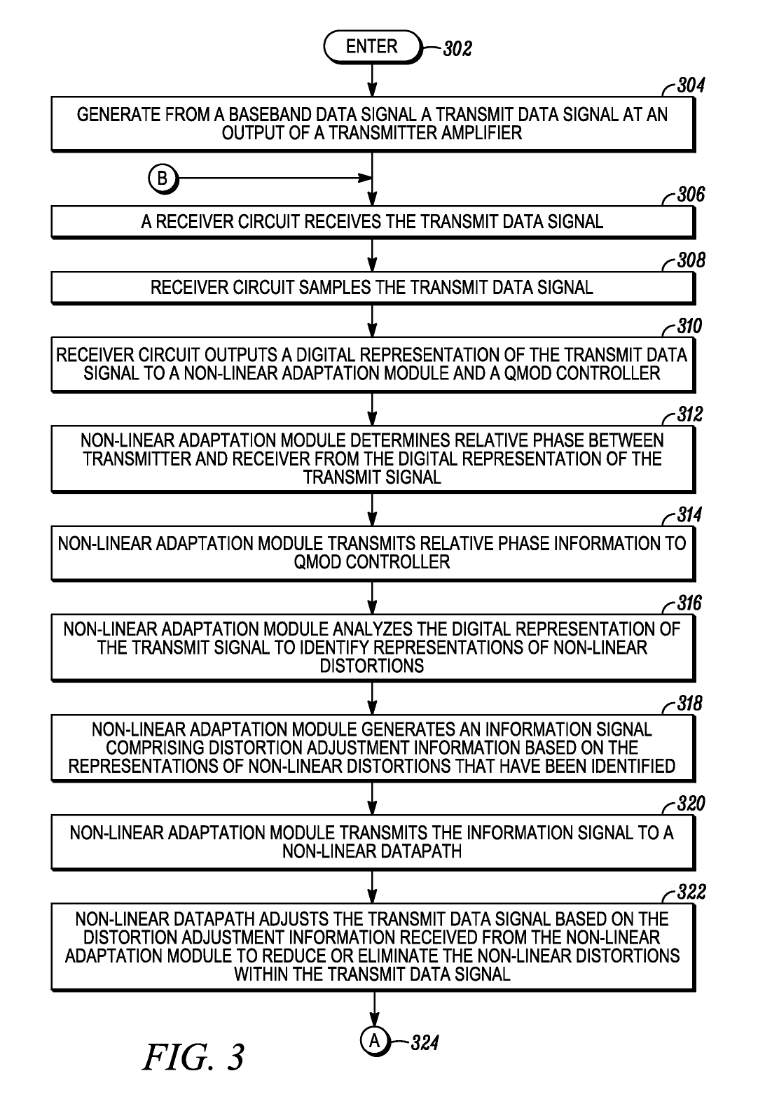

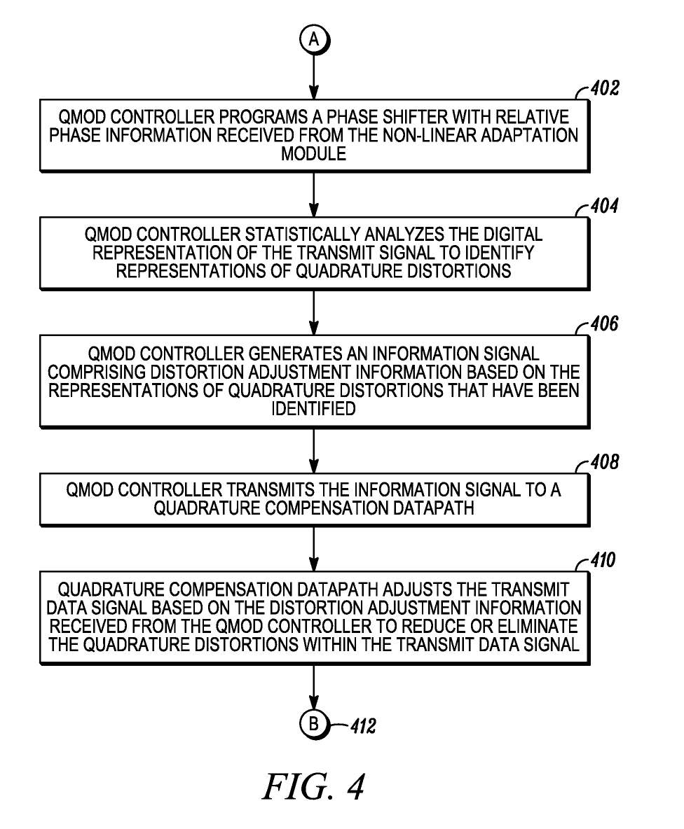

FIGS. 3 to 4 are operational flow diagrams illustrating one example of a process of managing and optimizing non-linear and quadrature distortions within a transmit data signal. The operational flow diagram of FIG. 3 begins at step 302, and flows directly into step 304. The transmitter 108, at step 304, generates, from a baseband data signal 202, a transmit data signal 235 at an output of a transmitter amplifier 214. A receiver circuit 238, at step 306, receives the transmit data signal 235. The receiver circuit 238, at step 308, samples the transmit data signal 235. The receiver circuit 238, at step 310, outputs a digital representation of the transmit data signal to a non-linear adaptation module 248 and a QMod controller 254. The non-linear adaptation module 248, at step 312, determines the relative phase between the transmitter and receiver portions of the transmitter system 108 from the digital representation of the transmit data signal. The non-linear adaptation module 248, at step 314, then transmits the relative phase information to the QMod controller 254.

The non-linear adaptation module 248, at step 316, analyzes the digital representation of the transmit data signal to identify representations of non-linear distortions. The non-linear adaptation module 248, at step 318, generates an information signal 252 comprising distortion adjustment information that is based on the representations of the non-linear distortions that have been identified. The non-linear adaptation module 248, at step 320, transmits the information signal to the non-linear datapath 208. The non-linear datapath 208, at step 322, adjusts the transmit data signal 235 based on the distortion adjustment information received from the non-linear adaptation module 248 to reduce or eliminate the non-linear distortions within the transmit data signal 235. The control then flows to entry point A of FIG. 4

The QMod controller 254, at step 402, programs a phase shifter 256 with the relative phase information received from the non-linear adaptation module 248. The QMod controller 254, at step 404, statistically analyzes the digital representation of the transmit data signal to identify representations of quadrature distortions. The QMod controller 254, at step 406, generates an information signal comprising distortion adjustment information based on the representations of quadrature distortions that have been identified. The QMod controller 254, at step 408, then transmits an information signal 268 to a quadrature compensation datapath 210. The quadrature compensation datapath 210, at step 410, adjusts the transmit data signal 235 based on the distortion adjustment information received from the QMod controller 254 to reduce or eliminate the quadrature distortions within the transmit data signal 235. The control then returns to step 306 of FIG. 3 where the above processes are continuously and automatically repeated.

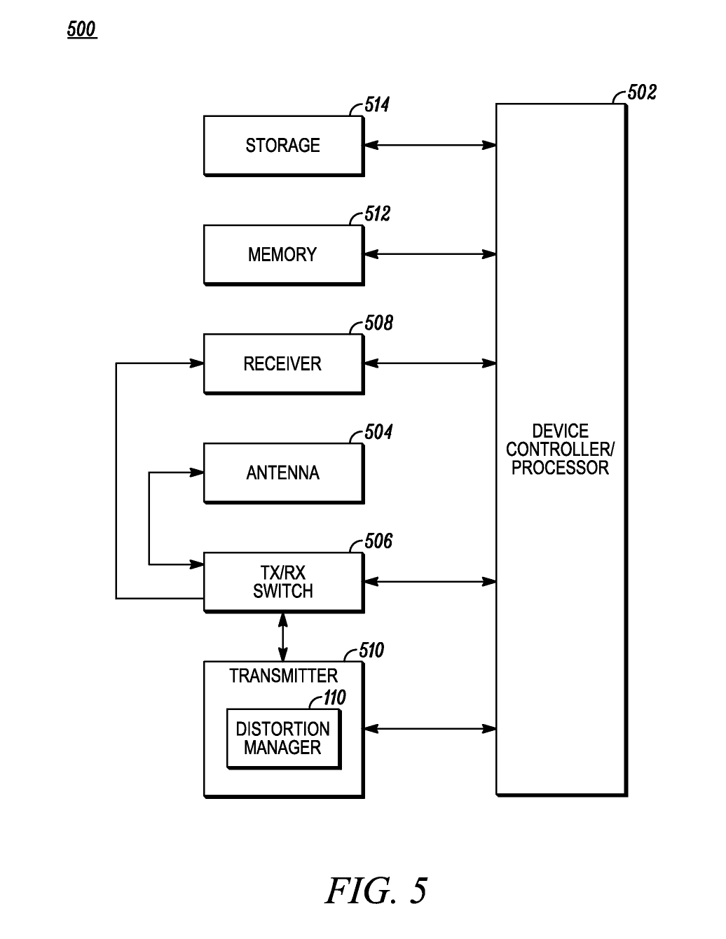

Referring now to FIG. 5, a more detailed view of a wireless device 500 is shown such as a wireless communication device 102, 104 or a base station 112. It is assumed that the reader is familiar with wireless devices. To simplify the present description, only that portion of a wireless device that is relevant to the present invention is discussed. The wireless device 500 shown in FIG. 5 operates under the control of a device controller/processor 502 that controls the sending and receiving of wireless communication signals and also performs the process discussed above with respect to FIG. 5. In receive mode, the device controller 502 electrically couples an antenna 504 through a transmit/receive switch 505 to at least one receiver 508. The receiver 508 decodes the received signals and provides those decoded signals to the device controller 502.

In transmit mode, the device controller 502 electrically couples the antenna 504, through the transmit/receive switch 505, to a one or more transmitters 510, which include a distortion manager 110. The distortion manager 110 has already been discussed above, and therefore, for the sake of brevity, will not be discussed in great detail here. The transmitter 510 is configured similar to the transmitter system 108 of FIG. 2 and also for the sake of brevity, will not be discussed in great detail here.

The transmit/receive switch 506, can include a diplexor/duplexor circuit for coupling transmitted signals from the transmitter(s) 510 to the antenna 504 and received signals from the antenna 504 to the receiver(s) 508. It should be noted that in one embodiment, the at least one receiver 508 and the transmitter 510 comprise dual mode receivers and dual mode transmitters for receiving/transmitting over various access networks providing different air interface types. The wireless device 500 also includes a memory 512 and non-volatile storage 514. The memory 512 and/or non-volatile storage 514 can include instructions, and store parameters, to perform the distortion management and optimization process discussed above with reference to FIGS. 3 and 4.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, with a wireless device, for managing quadrature and non-linear distortions in a transmitter system, the method comprising:
generating, from a baseband data signal, a transmit data signal at an output of a transmitter amplifier, wherein the transmit data signal can include one or more distortions selected from the set of: Non-linear distortions, Q-offset, I-offset, Quadrature imbalance, and Scaling;
receiving, by a radio frequency (“RF”) receiver circuit, the transmit data signal generated at the output of the transmitter amplifier;
generating, at an output of the RF receiver circuit, a received signal that comprises a digital representation of the received transmit data signal;
statistically analyzing the received signal;
identifying, in response to statistically analyzing the received signal, a representation of each distortion of the one or more distortions in the transmit data signal;
generating, in response to the identifying, at least one information signal comprising an information set of distortion adjustments associated with a representation of at least one of the one or more distortions in the transmit data signal; and
adjusting distortion of the transmit data signal based on the information set of distortion adjustment in the at least one information signal, wherein the adjusting reduces the at least one of the one or more distortions in the transmit data signal.

2. The method of claim 1, further comprising:
determining a relative signal phase between an output of a transmitter in the transmitter system and an output of the RF receiver circuit.

3. The method of claim 2, further comprising:
programming a phase shifter with a phase rotation corresponding to the relative phase that has been determined.

4. The method of claim 1, wherein statistically analyzing the received signal further comprises:
passing the received signal to a Q-offset filter and an I-offset filter; and
determining a Direct Current correction factor based on an output of the Q-offset filter and the I-offset filter.

5. The method of claim 1, wherein statistically analyzing the received signal further comprises:
passing the received signal to a Quadrature imbalance filter; and
determining a phase correction factor based on an output of the Quadrature imbalance filter.

6. The method of claim 1, wherein statistically analyzing the received signal further comprises:
passing the received signal to a Scaling imbalance filter; and
determining a scaling correction factor based on an output of the Scaling imbalance filter.

7. The method of claim 1, wherein the information set of distortion adjustments comprise at least one of Direct Current correction factor, a phase correction factor, and a scaling correction factor.

8. The method of claim 1, wherein adjusting distortion of the transmit data signal further comprises:
adjusting distortion of the transmit data signal prior to the transmit data signal being modulated by a quadrature modulator.

9. A wireless device that manages quadrature and non-linear transmit signal distortions, the wireless device comprising:
a memory;
a processor communicatively coupled to the memory; and
at least one transmitter communicatively coupled to the memory and the processor, wherein the at least one transmitter comprises a distortion manager and a radio frequency (“RF”) receiver circuit, and wherein the at least one transmitter is adapted to:
generate, from a baseband data signal, a transmit data signal at an output of a transmitter amplifier, wherein the transmit data signal can include one or more distortions selected from the set of: Non-linear distortions, Q-offset, I-offset, Quadrature imbalance, and Scaling;
wherein the RF receiver circuit is adapted to:
receive the transmit data signal generated at the output of the transmitter amplifier;
generate, at an output, a received signal that comprises a digital representation of the received transmit data signal; and
wherein the distortion manager is adapted to:
statistically analyze the received signal;
identify, in response to the received signal being statistically analyzed, a representation of each distortion of the one or more distortions in the transmit data signal;
generate, in response to the representation of each distortion being identified, at least one information signal comprising an information set of distortion adjustments associated with a representation of at least one of the one or more distortions in the transmit data signal; and
adjust distortion of the transmit data signal based on the information set of distortion adjustment in the at least one information signal, wherein adjusting the distortion reduces the at least one of the one or more distortions in the transmit data signal.

10. The wireless device of claim 9, wherein the distortion manager is further adapted to:
determine a relative signal phase between an output of one of the at least one transmitter and an output of the RF receiver circuit.

11. The wireless device of claim 10, wherein the distortion manager is further adapted to:
program a phase shifter with a phase rotation corresponding to the relative phase that has been determined.

12. The wireless device of claim 9, wherein the distortion manager is adapted to statistically analyze the received signal by:
passing the received signal to a Q-offset filter and an I-offset filter; and
determining a Direct Current correction factor based on an output of the Q-offset filter and the I-offset filter.

13. The wireless device of claim 9, wherein the distortion manager is adapted to statistically analyze the received signal by:
passing the received signal to a Quadrature imbalance filter; and
determining a phase correction factor based on an output of the Quadrature imbalance filter.

14. The wireless device of claim 9, wherein the distortion manager is adapted to statistically analyze the received signal by:
passing the received signal to a Scaling imbalance filter; and
determining a scaling correction factor based on an output of the Scaling imbalance filter.

15. The wireless device of claim 9, wherein the distortion manager is further adapted to adjust distortion of the transmit data signal by:
adjusting distortion of the transmit data signal prior to the transmit data signal being modulated by a quadrature modulator.

16. A wireless communication system that manages quadrature and non-linear transmit signal distortions, the wireless communication comprising:
at least one wireless network;
at least one wireless device communicatively coupled to the wireless network, wherein the at least one wireless device comprises:
a memory;
a processor communicatively coupled to the memory; and
at least one transmitter communicatively coupled to the memory and the processor, wherein the at least one transmitter comprises a distortion manager and a radio frequency (“RF”) receiver circuit, and wherein the at least one transmitter is adapted to:
generate, from a baseband data signal, a transmit data signal at an output of a transmitter amplifier, wherein the transmit data signal can include one or more distortions selected from the set of: Non-linear distortions, Q-offset, I-offset, Quadrature imbalance, and Scaling;
wherein the RF receiver circuit is adapted to:
receive the transmit data signal generated at the output of the transmitter amplifier;
generate, at an output, a received signal that comprises a digital representation of the received transmit data signal;
wherein the distortion manager is adapted to:
statistically analyze the received signal;
identify, in response to the received signal being statistically analyzed, a representation of each distortion of the one or more distortions in the transmit data signal;
generate, in response to the representation of each distortion being identified, at least one information signal comprising an information set of distortion adjustments associated with a representation of at least one of the one or more distortions in the transmit data signal; and
adjust distortion of the transmit data signal based on the information set of distortion adjustment in the at least one information signal, wherein adjusting the distortion reduces the at least one of the one or more distortions in the transmit data signal.

17. The wireless communication system of claim 17, wherein the distortion manager is adapted to statistically analyze the received signal by:
passing the received signal to a Q-offset filter and an I-offset filter; and
determining a Direct Current correction factor based on an output of the Q-offset filter and the I-offset filter.

18. The wireless communication system of claim 17, wherein the distortion manager is adapted to statistically analyze the received signal by:
passing the received signal to a Quadrature imbalance filter; and
determining a phase correction factor based on an output of the Quadrature imbalance filter.

19. The wireless communication system of claim 17, wherein the distortion manager is adapted to statistically analyze the received signal by:
passing the received signal to a Scaling imbalance filter; and
determining a scaling correction factor based on an output of the Scaling imbalance filter.

20. The wireless communication system of claim 17, wherein the distortion manager is further adapted to adjust distortion of the transmit data signal by:
adjusting distortion of the transmit data signal prior to the transmit data signal being modulated by a quadrature modulator.
